(19) United States
(12) Patent Application Publication
(10) Pub. No.: US 2008/0026252 A1
(43) Pub. Date: Jan. 31, 2008

(54) Method of manufacturing magnetic recording media, magnetic recording media, and magnetic recording apparatus

(75) Inventors: Koji Sonoda, Ome-shi (JP); Tsutomu Nakanishi, Tokyo (JP); Yasuyuki Hotta, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/878,898

(22) Filed: Jul. 27, 2007

(30) Foreign Application Priority Data
Jul. 28, 2006 (JP) 2006-206704

(51) Int. Cl. B44C 1/22; G11B 5/33

(52) U.S. Cl. 428/810; 216/22

(57) ABSTRACT

According to one embodiment, there is provided a method of manufacturing a magnetic recording media including depositing a magnetic layer on a substrate and processing the magnetic layer to form protruded magnetic patterns, depositing a planarizing layer in recesses between the magnetic patterns and on the magnetic patterns, and forming steps on a surface of the planarizing layer.

### CROSS-REFERENCE TO RELATED APPLICATIONS

This application is based upon and claims the benefit of priority from Japanese Patent Application No. 2006-206704, filed Jul. 28, 2006, the entire contents of which are incorporated herein by reference.

### BACKGROUND

1. Field

One embodiment of the present invention relates to a method of manufacturing a magnetic recording media, in particular, a patterned media, a magnetic recording media manufactured by the method, and a magnetic recording apparatus in which the magnetic recording media is installed.

2. Description of the Related Art

In recent years, in a magnetic disk apparatus (hard disk drive), interference between neighboring tracks and thermal fluctuation are factors that hinder increase in density. To cope with these problems, there have been proposed discrete track recording media in which recording tracks are formed of protruded magnetic patterns isolated from each other and patterned media in which a magnetic layer is processed into magnetic dots isolated from each other where each of the magnetic dots is used as one bit. The discrete track recording media are included in the patterned media in a broad sense.

In the prior art, in order to process a magnetic layer in a desired pattern shape, there is proposed, for example, a method in which projections are formed on the peripheral edge portion of the protruded patterns and the projections are removed after the magnetic layer is processed (Jpn. Pat. Appln. KOKAI Publication No. 2005-267736). According to this method, the peripheral edge portion of the magnetic patterns can be prevented from being rounded.

However, in the patterned media, there is a problem that the flying stability of a head slider is hard to secure, even in the case where the surface has recesses and protrusions reflecting the protruded magnetic patterns or in the case where the surface of a planarizing film formed on the magnetic patterns is made very flat. It is thus preferable that controlled steps be formed on the surface of the patterned media.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A, 1B, 1C, 1D, 1E, 1F, 1G, 1H and 1I are cross-sectional views illustrating a method of manufacturing a magnetic recording media according to an embodiment of the invention;

FIG. 2 is a perspective view of a magnetic disk apparatus according to an embodiment of the invention;

FIG. 3 is a graph showing an example of two Gaussian distribution curves which are fitted to a material ratio curve of roughness profile;

FIG. 4 shows a relationship between an etch-back time and a mean value difference (Δ value) with respect to planarizing layers which have been subjected to initial etching;

FIG. 5 shows a relationship between an etch-back time and a variance σ₂² of a Gaussian distribution curve closer to the surface with respect to planarizing layers which have been subjected to initial etching;

FIG. 6 shows a relationship between the Δ value and a frictional force; and

FIG. 7 shows a relationship between the variance σ₂² and a frictional force.

### DETAILED DESCRIPTION

Various embodiments according to the invention will be described hereinafter with reference to the accompanying drawings. In general, according to one embodiment of the present invention, there is provided a method of manufacturing a magnetic recording media, comprising: depositing a magnetic layer on a substrate and processing the magnetic layer to form protruded magnetic patterns; depositing a planarizing layer in recesses between the magnetic patterns and on the magnetic patterns; and forming steps on a surface of the planarizing layer.

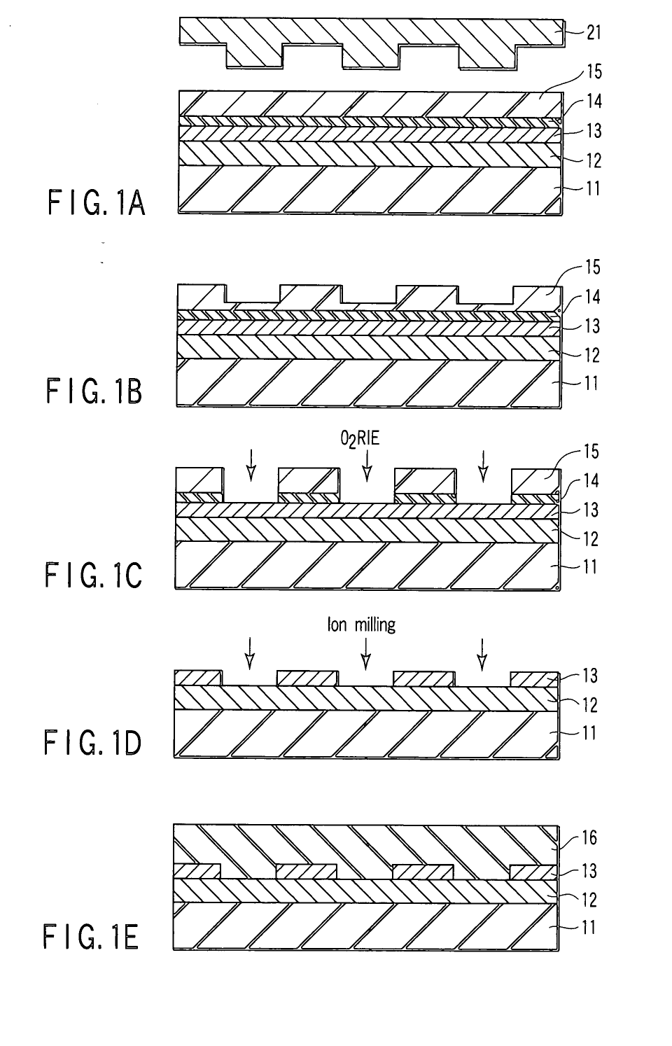

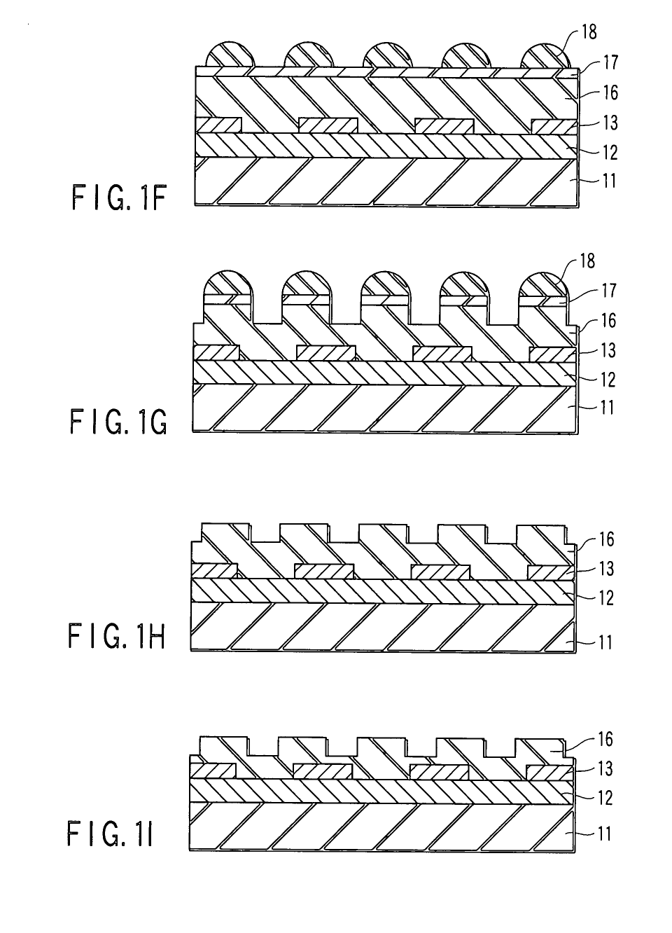

A method of manufacturing a magnetic recording media (a discrete track recording media or a patterned media) according to an embodiment of the present invention will now be described with reference to FIGS. 1A, 1B, 1C, 1D, 1E, 1F, 1G, 1H and 1I.

As is shown in FIG. 1A, a soft magnetic underlayer 12, a magnetic recording layer 13 and a protection layer 14 are formed on a substrate 11. A resist 15 is applied to the protection layer 14.

A glass substrate, a metal substrate, a plastic substrate or a Si substrate can be used as the substrate 11. The substrate may have a metal film or a dielectric film formed on the surface thereof. The shape of the substrate is not limited, and the substrate may be, for instance, a disk-shaped substrate with a size of 0.85 inch, 1 inch, 1.8 inches, 2.5 inches, or 3 inches. The substrate should preferably have a higher planarity.

In general, the soft magnetic underlayer 12 is provided under the magnetic recording layer 13 of a perpendicular magnetic recording media. In general, in order to regulate the crystal orientation of the magnetic recording layer 13, a plurality of metal or dielectric thin films are formed as underlayers of the magnetic recording layer 13.

The magnetic recording layer 13 is formed of a ferromagnetic material. Specifically, the magnetic recording layer 13 includes at least one ferromagnetic metal selected from Co, Fe and Ni. In usual cases, use is made of a material which includes, in addition to the ferromagnetic metal, at least one element selected from C, Si, Cr, Pt, Pd, Ta, Tb, Sm and Gd. The magnetic recording layer 13 may be a stack of a plurality of layers including these materials. In this case, a metal layer or a metal oxide layer of a metal, other than Co, Fe and Ni, may be inserted between the plurality of layers. The magnetic recording layer 13 is deposited by sputtering.

The protection layer 14 is provided in order to prevent oxidation of the magnetic recording layer 13. The protection layer 14 is formed of, for example, diamond-like carbon (DLC), and the thickness of the protection layer 14 should preferably be about 4 nm.

A novolak-based photoresist (S1801 or S1818 available from Shipley Co., etc.), for instance, can be used as the resist 15. Preferably, the resist 15 is spin-coated and has a thickness of about 120 nm.

Then, a stamper 21 is disposed so as to face the resist 15, and patterns of recesses and protrusions of the stamper 21 are transferred to the resist 15 by imprinting. The resist 15 having the transferred patterns of recesses and protrusions is subjected to UV irradiation and is baked at about 160° C. As a result, the novolak resin is cross-linked to have hardness enough to withstand ion milling.

As shown in FIG. 1B, in the imprinting process of forming the patterns of recesses and protrusions, resist residues remain on the bottoms of recesses of the resist pattern after the stamper 21 is removed. As the amount of the resist residues is smaller, the processing of the magnetic recording layer can be performed more preferably. However, if the amount of the resist residues is too small, the performance of the shape transfer by the imprinting would deteriorate.

As shown in FIG. 1C, the resist residues are removed by RIE using oxygen gas. In order to remove the resist residues with a least possible change of the transferred patterns of recesses and protrusions on the resist 15, it is preferable to perform RIE under with a low-pressure, high-density plasma source. It is thus preferable to perform RIE with an inductive-coupling plasma (ICP) type or an electron cyclotron resonance (ECR) type etching apparatus. For example, the ICP etching apparatus is used and oxygen RIE is carried out at an etching pressure of about 2 mTorr to remove the resist residues. At the same time, the protection layer 14 (DLC) is also removed from the bottoms of the recesses.

As shown in FIG. 1D, the magnetic recording layer 13 is etched by Ar ion milling. In order to prevent damage to the magnetic recording layer 13, the etching is performed by changing the ion incident angle between, for example, 30° and 70°, thus suppressing a re-deposition phenomenon. With the suppression of the re-deposition phenomenon, the side walls of the patterns of the magnetic recording layer 13 have a taper angle of about 40° to 75°. Subsequently, the resist 15 is removed by oxygen RIE. In order to effectively remove the resist 15, it is preferable to generate oxygen plasma at a high pressure and a high power. For example, the oxygen RIE is performed under the conditions of about 1 Torr and 400 W. In this case, the protection layer 14 (DLC) remaining on the patterns of the magnetic recording layer 13 is also removed. In consideration of the prevention of oxidation of the magnetic recording layer 13, it is preferable to stop the oxygen RIE before the DLC on the magnetic recording layer 13 is completely removed. In the present embodiment, at this stage, protruded patterns of the magnetic recording layer 13 with a height of about 20 nm are formed.

As shown in FIG. 1E, a layer of diamond-like carbon (DLC) with a thickness of about 50 nm is deposited as a planarizing layer 16 by sputtering or chemical vapor deposition (CVD). Recesses between the patterns of the magnetic recording layer 13 are filled with the planarizing layer 16, and the planarizing layer 16 is stacked on the patterns of the magnetic recording layer 13. At this time, an average surface roughness Ra of the planarizing layer 16 is about 0.6 nm. It is preferable to set the thickness of the planarizing layer 16, which is formed on the patterns of the magnetic recording layer 13, at 10 nm or more.

In the present embodiment, only the DLC is filled in the recesses between the patterns of the magnetic recording layer 13 and is stacked on the patterns of the magnetic recording layer 13. Alternatively, a plurality of kinds of materials may be used. For example, a thin protection layer may be formed on the surface of the patterns of the magnetic recording layer 13, a filling material other than DLC may be filled in the recesses between the patterns of the magnetic recording layer 13, and further a planarizing layer of DLC may be stacked on the patterns. In this case, DLC with a high ratio of sp³-bonded carbon is preferable as the protection layer. A layer of DLC is formed by sputtering using a graphite target, or by CVD. CVD is preferable when DLC with a higher sp³-bonded carbon content is to be formed. The thickness of this protection layer should preferably be as small as possible. However, if the thickness is too small, the coverage of DLC on the patterns of the magnetic recording layer 13 becomes poor, and thus the thickness should preferably be 3 to 4 nm. The filling material can be selected from a wide range of nonmagnetic materials including oxides such as SiO₂, TiOₓ and Al₂O₃, nitrides such as Si₃N₄, AlN and TiN, carbides such as TiC, borides such as BN, and single elements such as C and Si.

Next, a method of forming steps on the surface of the planarizing layer 16 is described with reference to FIGS. 1F, 1G, 1H and 1I.

As shown in FIG. 1F, a mask underlayer 17 is formed on the planarizing layer 16, and island-shaped etching mask patterns 18 are formed on the mask underlayer 17. The characteristics required for the mask underlayer 17 are that the affinity of the mask underlayer 17 for the etching mask material formed thereon is lower than the affinity for the DLC and the formation of island-shaped etching mask patterns 18 is made easier. In this embodiment, perfluoropolyether (Fomblin Z-Tetraol available from Solvey Solexis) is applied with a thickness of about 2 nm as the mask underlayer 17. A polymer film or a plasma polymerized film, for instance, can also be used as the mask underlayer 17.

In the present embodiment, the etching mask pattern 18 is formed by making use of the self-assembling of a low-molecular-weight organic compound. Examples of the low-molecular-weight organic compound include tetratriphenylaminoethylene (TTPAE) such as tetra(N,N-diphenyl-4-aminophenyl)ethylene; triphenyldiamine (TPD) such as N,N-bis(4-methylphenyl)-N,N-bisphenylbenzidine; and trishydroxyquinolino aluminum (Alq₃) such as tris(8-hydroxyquinolino)aluminum. These low-molecular-weight organic compounds are sublimated by low-temperature heating at 400° C. or less. The sublimed low-molecular-weight organic compound is deposited with a small thickness on the mask underlayer 17. Thus, island-shaped etching mask patterns 18 can be formed.

In order to advantageously form the island-shaped etching mask patterns 18, the following method may be used. For example, the substrate may be heated at the time of depositing a film of the low-molecular-weight organic compound, or the substrate may be heated after the film of the low-molecular-weight organic compound is deposited. These methods are effective in controlling the area that is occupied by the island-shaped etching mask patterns 18. The size and the area of occupation of the etching mask patterns 18 can also be controlled by the film formation rate of the low-molecular-weight organic compound. In other words, if the deposition rate is low, the density of nuclei of the low-molecular-weight compound, which grows in an island shape, increases. Accordingly, the etching mask patterns 18 can be formed with a higher density. In the present embodiment, triphehyldiamine (TPD) is used as an etching mask material. After a film of the etching mask material is deposited, the deposited film is heated at 110° C. for one minute and the island-shaped etching mask patterns 18 with a height of about 50 nm are formed. The diameter of each etching mask pattern 18 is 50 to 100 nm, and the area thereof is about several μm².

It is conceivable to use a resist, which is patterned by photolithography, as the etching mask pattern. This technique, however, is not preferable since an expensive exposure apparatus is needed in order to form sub-micron patterns, and this technique is not suited to mass-production in terms of time and cost. It is also conceivable to use a resist, which is patterned by a relatively inexpensive nano-imprinting method, as the etching mask pattern. This technique, however, is not preferable since etching of the planarizing layer 16 become non-uniform due to dispersion of thickness of resist residues occurring at the time of imprinting.

As shown in FIG. 1G, using the etching mask patterns 18 as masks, the planarizing layer 16 is partly etched. Hereinafter, this etching is referred to as “initial etching”. By the initial etching, steps with a depth of between 2 nm and 8 nm are formed on the surface of the planarizing layer 16.

The planarizing layer 16 can be etched by, for example, plasma etching using oxygen gas. In addition, the planarizing layer 16 can also be etched by ion-beam etching using an inert gas such as argon ions. In the case of using the ion-beam etching, it is preferable to increase the height of the etching mask patterns 18 since the sputter-etching rate of DLC is very low. The etching gas is not limited to oxygen and argon.

In the present embodiment, an ICP etching apparatus is used, and the planarizing layer 16 is etched by oxygen RIE (reactive ion etching) by using the etching mask patterns 18 as masks under the conditions that the gas flow rate is 40 sccm, the pressure is 20 mTorr and the coil power is 10 W. If the pressure is set to be lower, the anisotropy is increased and thus the shapes of recesses and protrusions can advantageously be maintained.

In this case, the time for initial etching was set at 30 seconds or 2 minutes. If the initial etching time is set at 30 seconds, steps with a depth of 8 nm or less are formed on the surface of the planarizing layer 16. If the initial etching time is set at 2 minutes, steps with a depth greater than 8 nm are formed on the surface of the planarizing layer 16.

As shown in FIG. 1H, the etching mask patterns 18 are removed. Since the constituent molecules of the etching mask patterns 18 are sublimated at low temperatures of 400° C. or below, the residues of the etching mask patterns 18 can easily be removed by heat treatment of the substrate. In the embodiment, the substrate is put in a vacuum oven of 1 Torr or less and is heated at 200° C. for 2.5 hours so as to remove the etching mask patterns 18. Since the residues of the etching mask patterns 18 are an agglomerate of organic molecules, the residues can also be removed easily by using an organic solvent.

As shown in FIG. 1I, the surface of the planarizing layer 16 is etched back once again by oxygen RIE in the state that the steps on the surface are maintained. The thickness of the remaining planarizing layer 16 is set in a range of between 5 nm and 2 nm. The conditions for the oxygen RIE at this time may be the same as those for the initial etching.

In order to set the thickness of the remaining planarizing layer 16 at 5 nm or less, the etch-back time is set at 3.5 minutes or more in the case where the initial etching time is set at 30 seconds, and the etch-back time is set at 2 minutes or more in the case where the initial etching time is set at 2 minutes.

In the meantime, a problem will arise with a method in which the etching mask patterns 18 are not removed, unlike the step shown in FIG. 1H, and the planarizing layer 16 is etched back in the state that the etching mask patterns 18 are present on the planarizing layer 16, and steps are formed on the surface of the planarizing layer 16. In the case where this method is adopted, since the thickness of a peripheral portion of the etching mask patterns 18 on the planarizing layer 16 is small, the peripheral portion of the top of the planarizing layer 16 is etched and rounded due to long-time etch-back. If the peripheral portion of the top the planarizing layer 16 is rounded as in this case, the flying stability of the head deteriorates and, disadvantageously, abrasion tends to easily occur due to contact with the head.

Although not shown, Fomblin Z-Tetraol (available from Solvey Solexis) with a thickness of about 2.0 nm is formed as a lubricant by dip coating on the surface of the etched-back planarizing layer 16, and a media for a hard disk drive is thus manufactured.

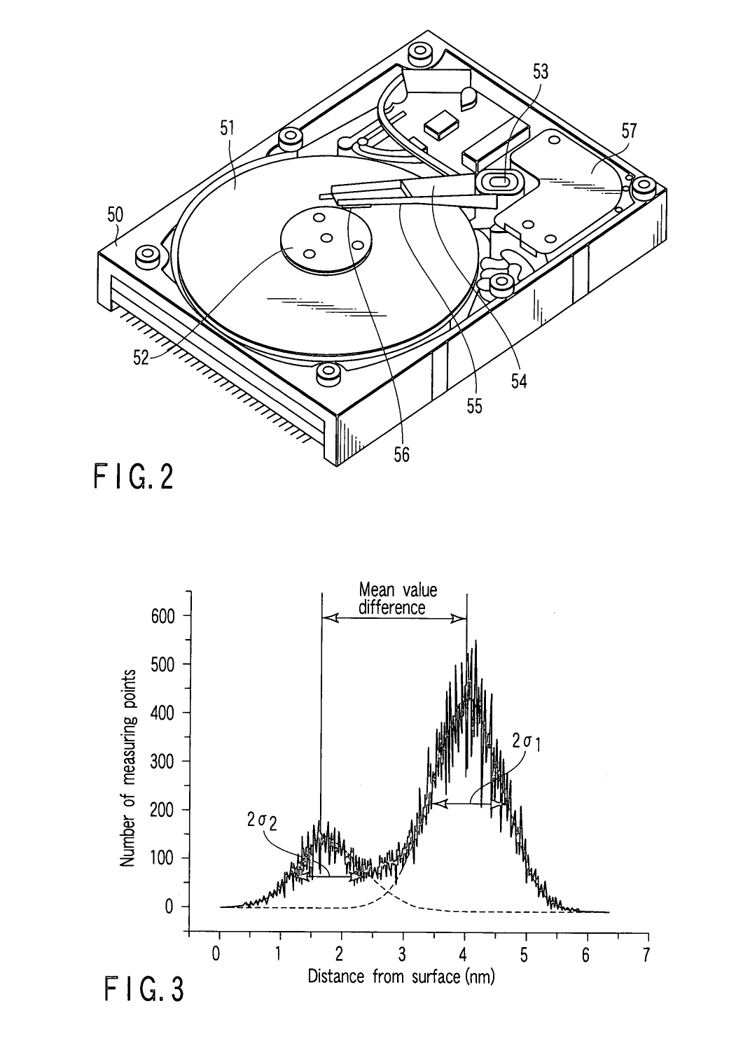

FIG. 2 is a perspective view showing a magnetic disk apparatus (hard disk drive) according to the embodiment of the present invention. This magnetic disk apparatus includes, within a chassis 50, a magnetic disk 51 manufactured by the above-described method, a head slider 56 including a magnetic head, a head suspension assembly (a suspension 55 and an actuator arm 54) which supports the head slider 56, a voice coil motor (VCM) 57, and a circuit board. The head slider 56 is of a flying type with a flying height of 10 nm or less, or of an in-contact type.

The magnetic disk (patterned media) 51 according to the embodiment is attached to a spindle motor 52 so as to be rotated. Various digital data are recorded on the magnetic disk 51 by a perpendicular magnetic recording system. The magnetic head, which is built in the head slider 56, is a so-called composite head which includes a single-pole write head, and a read head using a shielded MR read element such as a GMR film and a TMR film. The suspension 55 is held at one end of the actuator arm 54, and the head slider 56 is supported by the suspension 55 so as to face the recording surface of the magnetic disk 51. The voice coil motor (VCM) 57 is provided at the other end of the actuator arm 54. The voice coil motor (VCM) 57 drives the head suspension assembly and positions the magnetic head at an arbitrary radial position on the magnetic disk 51. The circuit board includes a head IC and generates driving signals for the voice coil motor (VCM) and control signals for controlling read/write by the magnetic head.

The manufactured media and the magnetic disk apparatus were evaluated as follows.

(1) Evaluation of the Surface Structure of the Media

The surface structure of the media, which was manufactured by the above-described method, was evaluated by using an atomic force microscope (AFM) (Digital Instruments NanoScope IIIa). The range of measurement was 1 μm×1 μm, and the number of scan lines was 256. Prior to performing a calculation of a material ratio curve of roughness profile, a filter process Flatten (order=0) for measured data was executed. The obtained material ratio curve of roughness profile was fitted to two Gaussian distribution curves. These Gaussian distribution curves are expressed by:

$$y = \frac{A}{2 σ \sqrt{π}} exp ( - \frac{{( x - μ )}^{2}}{2 {σ}^{2}} )$$

(where σ² is a variance and μ is a mean value).

FIG. 3 shows two Gaussian distribution curves which are fitted to a material ratio curve of roughness profile. In FIG. 3, the abscissa indicates a distance from the surface, and the ordinate indicates the number of measuring points of 256×256 measuring points, which represent a distance from a specified surface. In FIG. 3, a peak farther from the surface corresponds to bottoms of the surface steps of the planarizing layer, and a peak closer to the surface corresponds to tops of the surface steps of the planarizing layer. Hence, σ values (σ₁, σ₂) of the two Gaussian distribution curves and a difference (Δ=μ₁−μ₂) between the mean values of the two Gaussian distribution curves are found. The Δ value corresponds to the depth of the surface steps.

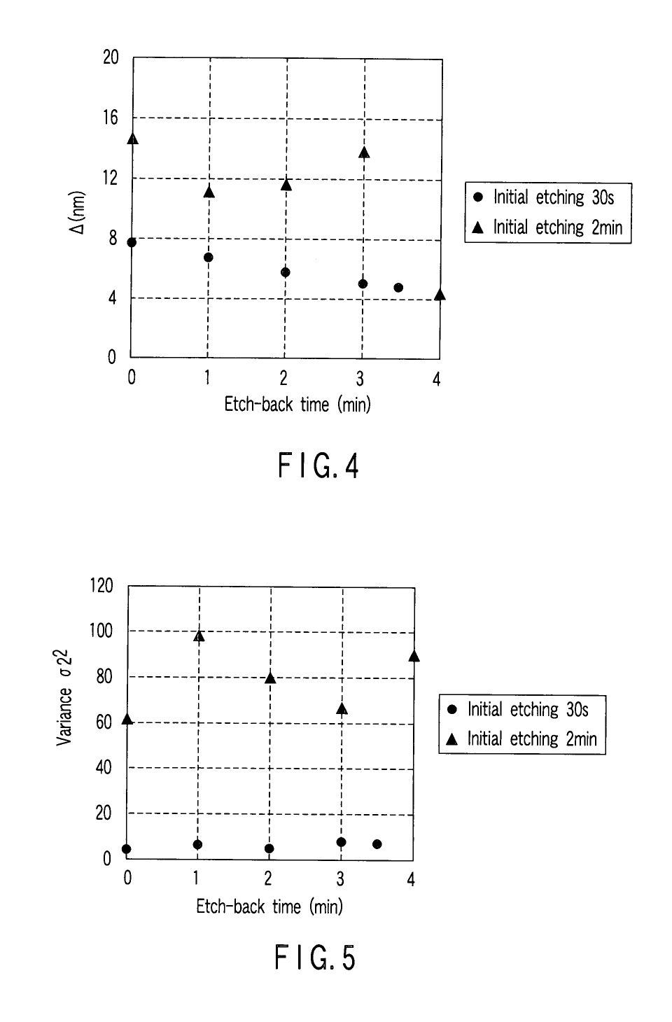

FIG. 4 shows a relationship between an etch-back time and a mean value difference (Δ value) with respect to planarizing layers which were subjected initial etching for 30 seconds and 2 minutes, respectively. In the planarizing layer which was subjected to the initial etching for 30 seconds, the depth of the steps at the initial stage is about 8 nm. As regards this planarizing layer, the Δ value decreases linearly as the etch-back time increases, and it is understood that the surface steps can be controlled even if the etch-back thickness is increased to 40 nm or more. In the planarizing layer which was subjected to the initial etching for 2 minutes, the depth of the steps at the initial stage is about 15 nm. As regards this planarizing layer, no constant tendency appears in the variation in Δ value in relation to the etch-back time, and it is understood that the control of the surface steps is difficult. The reason why the Δ value sharply decreases when the planarizing layer is etched back for four minutes is considered to be that after the bottoms of the planarizing layer were removed and the magnetic layer was exposed, the etching of the residual planarizing layer progressed.

FIG. 5 shows a relationship between an etch-back time and a variance σ₂² of the Gaussian distribution curve closer to the surface with respect to planarizing layers which were subjected to initial etching for 30 seconds and 2 minutes, respectively. Compared to the planarizing layer that was subjected to the initial etching for 30 seconds, the planarizing layer that was subjected to the initial etching for 2 minutes has a very large variance σ₂². It is thus understood that the peripheral edge portion of the top of the planarizing layer, which was subjected to the initial etching for 2 minutes, is rounded. If the peripheral edge portion of the top of the planarizing layer is rounded in this fashion, there is a disadvantage that abrasion due to contact with the head tends to easily occur.

(2) Evaluation with an in-Contact Head

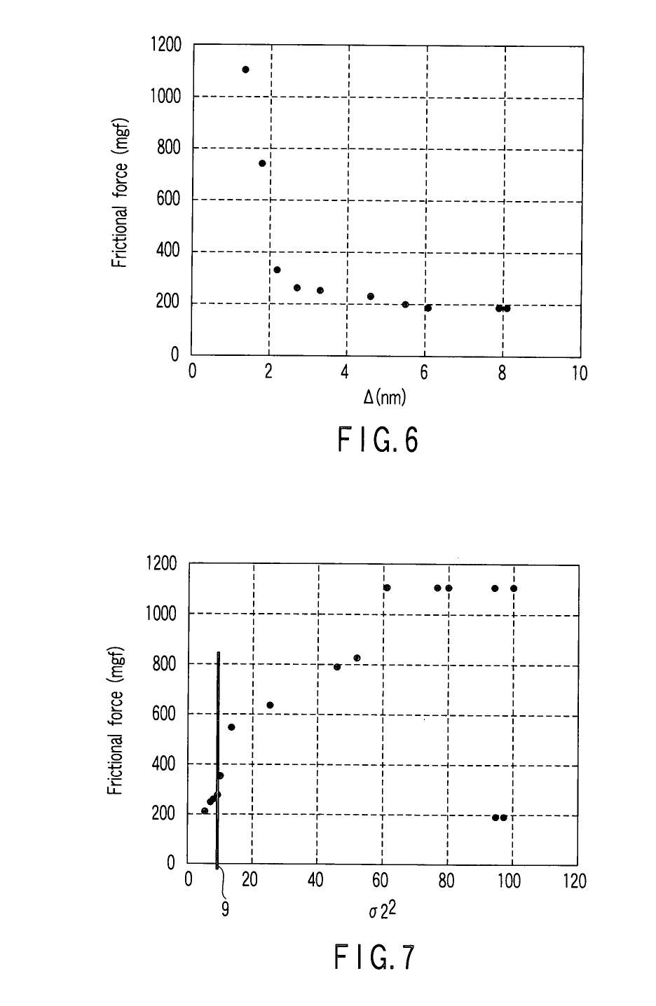

A magnetic recording media having a Δ value in a range of between 1 nm and 8 nm and a variance σ₂² of 9 or less and a magnetic recording media having a Δ value in a range of between 5 nm and 15 nm and a variance σ₂² in a range of between 5 and 100 were manufactured by varying the initial etching time. Each magnetic recording media and an in-contact magnetic head (Pico slider) with a head load of 2.5 gf were assembled in a tester, and a frictional force was measured. FIG. 6 shows a relationship between the Δ value and the frictional force. The frictional force at this time was measured after the passage of 5 seconds. FIG. 7 shows a relationship between the variance σ₂² and the frictional force. The frictional force at this time was measured after the passage of 5 minutes.

As shown in FIG. 6, if the Δ value decreases to less than 2 nm, the frictional force sharply increases. Hence, it is desirable that the Δ value be 2 nm or more.

As shown in FIG. 7, if the variance σ₂² exceeds 9, the frictional force sharply increases. The reason for this is considered to be that if the variance σ₂² exceeds 9 and the peripheral edge portion of the top of the planarizing layer is rounded, abrasion tends to easily occur due to contact with the head and the cycle that abrasion powder further progresses abrasion is repeated. Hence, it is desirable that the variance σ₂² be 9 or less.

(3) Evaluation with a Flying Head

A magnetic recording media having a Δ value of 2.5 nm and a variance σ₂² of 5 and a low-flying head (Femto slider) having a flying height of 10 nm or less were assembled in a magnetic disk apparatus. Under a reduced-pressure environment of 0.7 atm, a random-seek test over the entire surface (measurement of a time that is needed for read/write over the entire surface) was performed. As a result, even after 24 hours, there occurred neither performance degradation nor error occurrence.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of manufacturing a magnetic recording media, comprising:
depositing a magnetic layer on a substrate and processing the magnetic layer to form protruded magnetic patterns;
depositing a planarizing layer in recesses between the magnetic patterns and on the magnetic patterns; and
forming steps on a surface of the planarizing layer.

2. The method according to claim 1, comprising:
forming a mask underlayer on the planarizing layer, after the planarizing layer is deposited;
forming island-shaped etching mask patterns on the mask underlayer;
partly etching the planarizing layer using the etching mask patterns as masks to form steps on the surface of the planarizing layer;
removing the etching mask patterns; and
etching back the planarizing layer while substantially maintaining the steps on the surface thereof.

3. The method according to claim 2, wherein a thickness of the planarizing layer formed on the magnetic patterns is set at 10 nm or more, steps formed on the surface of the planarizing layer by partly etching the planarizing layer using the etching mask patterns as masks have a depth of 8 nm or less, and a residual thickness of the planarizing layer remained after the planarizing layer is etched back is set at nm or less.

4. The method according to claim 3, wherein a material ratio curve of roughness profile of the planarizing layer after etching-back is represented by two Gaussian distribution curves, a variance of one of the Gaussian distribution curves closer to a surface is 9 or less, and a mean value difference of the two Gaussian distribution curves is 2 nm or more.

5. A magnetic recording media manufactured by the method according to claim 1.

6. A magnetic recording apparatus comprising:
the magnetic recording media according to claim 5; and
a magnetic head selected from the group consisting of a flying magnetic head with a flying height of 10 nm or less and an in-contact magnetic head.
